(19) United States
(12) Patent Application Publication
(10) Pub. No.: US 2008/0062415 A1
(43) Pub. Date: Mar. 13, 2008

(54) Method of optically inspecting and visualizing optical measuring values obtained from disk-like objects

(75) Inventor: Detlef Michelsson, Wetzlar-Naunheim (DE)

Correspondence Address: Davidson, Davidson & Kappel, LLC, 485 17th Avenue, 14th Floor, New York, NY, 10018, US

(73) Assignee: Vistec Semiconductor Systems GmbH, Wetzlar (DE)

(21) Appl. No.: 11/784,947

(22) Filed: Apr. 10, 2007

(30) Foreign Application Priority Data
Sep. 13, 2006 (DE) DE102006042 956.7
Apr. 7, 2007 (DE) DE102006016 465.2

(51) Int. Cl. G06F 19/00

(52) U.S. Cl. 356/237.5; 356/237.2

(57) ABSTRACT

A method of visualizing measuring values from recorded images of disk-like objects is disclosed. First an image is recorded of at least one disk-like object, and a great number of measuring values is generated. Each measuring value is associated with a color value. Finally a resulting image is generated wherein an area which has resulted in a measuring value on the disk-like substrate is associated with a color value selected from a predetermined palette.

This claims the benefit of German Patent Application No. 10 2006 016 465.2, filed on Apr. 7, 2006 and German Patent Application No. 10 2006 042 956.7, filed on Sep. 13, 2006 and both of which are hereby incorporated by reference herein.

The present invention relates to a method of optically inspecting and visualizing optical measuring values of at least one image recorded of a disk-like object.

### BACKGROUND

In the production of semiconductors, during the manufacturing process, wafers are sequentially processed in a plurality of process steps. As integration densities increase, the requirements as to the quality of the structures formed on the wafer become ever more demanding. To be able to verify the quality of the structures formed and to find defects, if any, the requirements as to the quality, the precision and the reproducibility of the components and process steps for handling the wafer are correspondingly stringent. This means that in the production of a wafer comprising a great number of process steps and with the great number of layers of photoresist or the like to be applied, the reliable and early detection of defects is particularly important. In the optical detection of defects, it is a question of taking into account systematic defects due to thickness variations in the application of photoresist on the semiconductor wafer, so as to avoid marking positions on the semiconductor wafer that do not include a defect.

German Patent Application No. 10 307 454 A1 discloses a method, an apparatus and a software for optically inspecting the surface of a semiconductor substrate, and a method and an apparatus for manufacturing a structured semiconductor substrate using such a method or such an apparatus. In the method, an image is recorded for optically inspecting the surface of a semiconductor substrate. The image consists of a plurality of pixels each having at least three associated intensities of differing wavelengths, which are referred to as color values. From the color values, a frequency distribution of pixels having the same coordinate values is calculated by transformation into a color space spanned by an intensity and by color coordinates. The thus calculated frequency distribution is used for comparison with a second correspondingly calculated frequency distribution or a quantity derived therefrom. This method does not allow visual comparison or visual inspection of a disk-like object.

Macroscopic images of semiconductor wafers show that the homogeneousness of the layers varies radially. In particular in the application of photoresist, changes in the homogeneousness occur in the areas remote from the center of the wafer. If a uniform sensitivity is used across the entire radius of the wafer for the evaluation of images of the imaged wafer, as has hitherto been the case, deviations at the edge may always be detected, while defects in the middle (near the center of the wafer) are not detected. If a high sensitivity is selected to ensure that defects in homogeneous areas are reliably detected, there is an increase in erroneous detections in the edge areas, since the inhomogeneous edge areas are not always to be evaluated as defects. To avoid this, the edge areas may be completely excluded. Real defects will then be missed, however. On the other hand, if a lower sensitivity is selected, there may be no more erroneous detections, but defects in the homogeneous areas may go undetected.

German Patent Application No. 103 31 686.8 A1 discloses a method of evaluating recorded pictures of wafers or other disk-like objects. The recording of the image of at least one reference wafer is followed by obtaining and showing the radial distribution of the measuring values of the reference wafer as a radial homogeneousness function on a user interface. A radially dependent sensitivity profile is varied with respect to the measured radial homogeneousness function of the reference wafer. At least one parameter of the sensitivity profile is varied enabling a trained sensitivity profile to be visually determined from the comparison with the radial homogeneousness function. This method likewise does not show an image of the entire wafer, with the aid of which the image or the images could be evaluated with respect to the defects.

U.S. Pat. No. 7,065,460 discloses an apparatus and a method for inspecting semiconductor components. The apparatus is used to inspect the electric properties of a semiconductor product. The measuring results obtained from the inspection are shown on a display in association with various colors.

The illustrative representation of measuring values in the form of curves in diagrams only makes sense for one dimension of the distribution of the measuring points. If the measuring points are distributed in space, however, an illustration will reduce them to one dimension. As a result information is lost. Even a representation in a 3-D plot does not always lead to an illustrative representation due to overlaps. It is very difficult to show a link between the original information and measuring values. The representation in the form of numbers does not allow any conclusions as to the spatial distribution of the measuring values.

### SUMMARY OF THE INVENTION

An object of the present invention is to provide a visual method allowing a spatial distribution of possible defects on the surface of a disk-like substrate to be obtained reliably and quickly.

The present invention provides a method of optically inspecting and visualizing optical measuring values from at least one image of a disk-like object. In a first step at least one image of the at least one disk-like object is recorded, wherein a plurality of optical measuring values is generated from the at least one recorded image. In a second step each optical measuring value is associated with a color value. Finally a resulting image is generated.

The invention is advantageous in that at first at least one image of the at least one disk-like object is recorded, wherein a plurality of optical measuring values is generated from the at least one recorded image. This is followed by associating a color value with each optical measuring value. A resulting image is generated from the optical measuring values, wherein a portion of the area of the disk-like object, the optical measuring values of which are within a predetermined interval, is associated with a color value selected from a predetermined palette.

The resulting image may have the same size as the recorded image. The palette may have at least three different colors in which the resulting image is shown. The palette may define an association rule between measuring value and color value, by which images of the surface of the disk-like object are shown in different colors.

A threshold value can also be determined for differentiation. As a result a difference is formed between the measuring values of the recorded image and the threshold value.

In a particular embodiment, the palette can be graded from green to white to red. The gradation of the palette from green to white to red serves to visualize the signal-to-noise ratio, wherein green areas arise where the measuring value is remote from the threshold value and red areas indicate regions where the measuring value exceeds the threshold value.

The recorded image and the resulting image may be shown on the display of the system, wherein for evaluating defects on the disk-like substrate, a switchover can be made between the recorded image and the resulting image. The selection of the palette is at the discretion of the user. For quick detection of areas with or without defects, a palette with a gradation over three colors has proven useful.

The disk-like object can be a flat panel display or a wafer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject invention is schematically shown in the drawing and will be described in the following with reference to the figures, in which:

FIG. 1 is a schematic representation of a system for detecting defects on wafers or disk-like substrates;

FIG. 2a is a representation of the type of recording of the images or image data of a wafer;

FIG. 2 is a schematic plan view of a wafer;

FIG. 3 is a view of a wafer on a display of the system and for comparison a real recorded image of the wafer;

FIG. 4 is a view of the surface of the wafer wherein the difference to a threshold value has been formed; and

FIG. 5 is a false-color image of the surface of the wafer in a black and white representation.

### DETAILED DESCRIPTION OF THE INVENTION

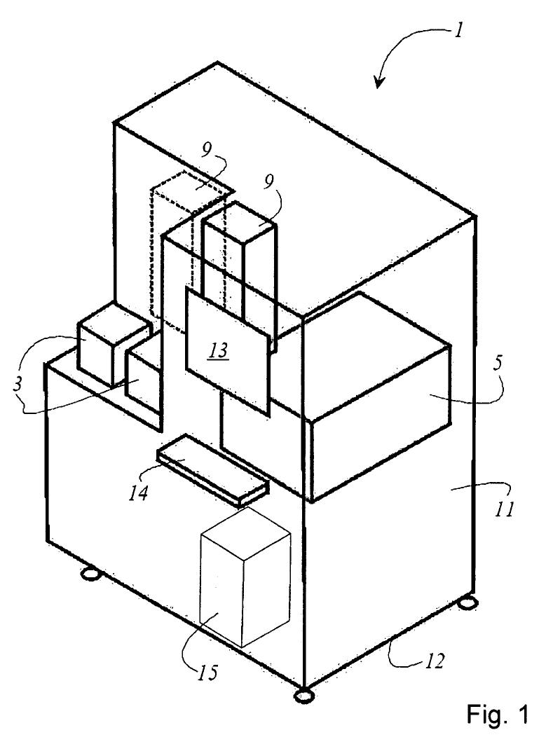

FIG. 1 shows a system 1 for detecting defects on wafers. System 1 comprises, for example, at least one cartridge element 3 for the semiconductor substrates or wafers. In a measuring unit 5, images or image data are recorded of the individual wafers. A transportation mechanism 9 is provided between cartridge element 3 for the semiconductor substrates or wafers and measuring unit 5. System 1 is surrounded by housing 11, wherein housing 11 defines a base 12. In system 1, further a computer 15 is incorporated for recording and processing images and image data of the individual measured wafers. System 1 is equipped with a display 13 and a keyboard 14. Keyboard 14 enables the user to input data for controlling the system or to input parameters for evaluating the image data of the individual wafers. A plurality of user interfaces are shown to the user on display 13.

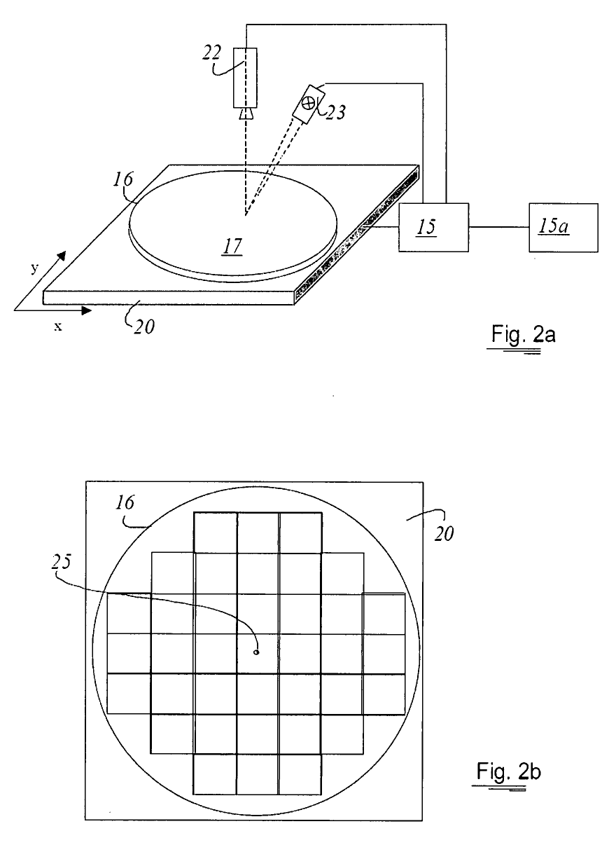

FIG. 2a shows a schematic representation of the manner in which the images and/or image data are detected from a wafer 16. Wafer 16 is placed on a stage 20 traversable within housing 11 in a first direction X and a second direction Y. The first and second directions X, Y are at right angles to each other. An image recorder 22 is provided above the surface 17 of wafer 16, wherein the field of view of image recorder 22 is smaller than the overall surface 17 of wafer 16. To be able to image the whole surface 17 of wafer 16 with the aid of image recorder 22, wafer 16 is scanned in a meandering fashion. The sequentially recorded image fields are then assembled to a total image of surface 17 of a wafer 16. This is also carried out by computer 15 provided in housing 11. For relative movement between stage 20 and image recorder 22, in the present exemplary embodiment, an X-Y-scanning stage is used, able to be traversed in the coordinate directions X and Y. Camera 22 is fixedly installed facing stage 20. On the other hand, stage 20 can of course also be fixedly installed while the image recorder 22 would then have to be moved across wafer 16 for imaging. A combination of the movement of image recorder 22, such as a camera, in one direction and of stage 20 in a direction vertical to it, is also possible. Wafer 16 is illuminated by an illumination device 23 for illuminating at least those portions on wafer 16 which correspond to the field of view of image recorder 22. Due to the concentrated illumination, which can also be pulsed with the aid of a flash lamp, imaging is also possible on the fly, i.e. wherein stage 20 or image recorder 22 are traversed without stopping for the imaging process. In this way a large wafer throughput is possible. It is of course also possible to stop the relative movement between stage 20 and image recorder 22 for each frame, and also to illuminate wafer 16 over its entire surface 17. Stage 20, image recorder 22 and illumination device 23 are controlled by computer 15. The frames can be stored by computer 15 in a memory 15a and retrieved from there as necessary.

FIG. 2b is a plan view of a wafer 16 placed on a stage 20. Wafer 16 has a center point 25. Layers are applied to wafer 16, which are then structured in a further process step. A structured wafer comprises a great number of structured elements.

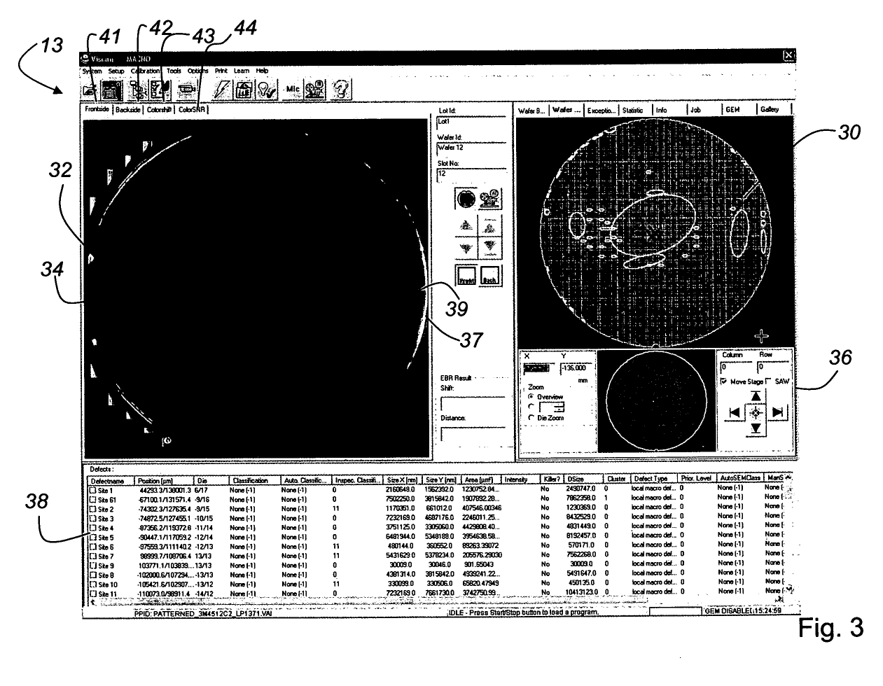

FIG. 3 is a view of a wafer 30 shown on display 13 of system 1 and for comparison the real recorded image 32 of wafer 30. For this purpose display 13 is essentially divided into a first area 34, a second area 36 and a third area 38. First area 34 shows the image of wafer 30 as it is recorded by camera 22. Second area 36 shows wafer 30 in a plan view, wherein areas of possible defects are indicated by circles or elliptical elements. In recorded image 32 of wafer 30, defects or areas with defects are not directly discernible. All that is discernible is a bright patch at a position 39 at the edge 37 of wafer 30, indicating a defect. Further it is possible to choose between four different representations of the recorded image of wafer 30 in first area 34. The front view of an image of wafer 30 can be shown and viewed on display 13 by means of a first tab 41. The user can switch over to a view of the back of wafer 30 by means of second tab 42 to view an image of the back of wafer 30. The user can select a color shift for the recorded image of wafer 30 by means of the third tab 43. A color representation of the signal-to-noise ratio of the surface of wafer 30 can be chosen by the user with the aid of a fourth tab 44.

In the third area 38, the user of system 1 can obtain alphanumeric information on the possible defects on the surface of wafer 30.

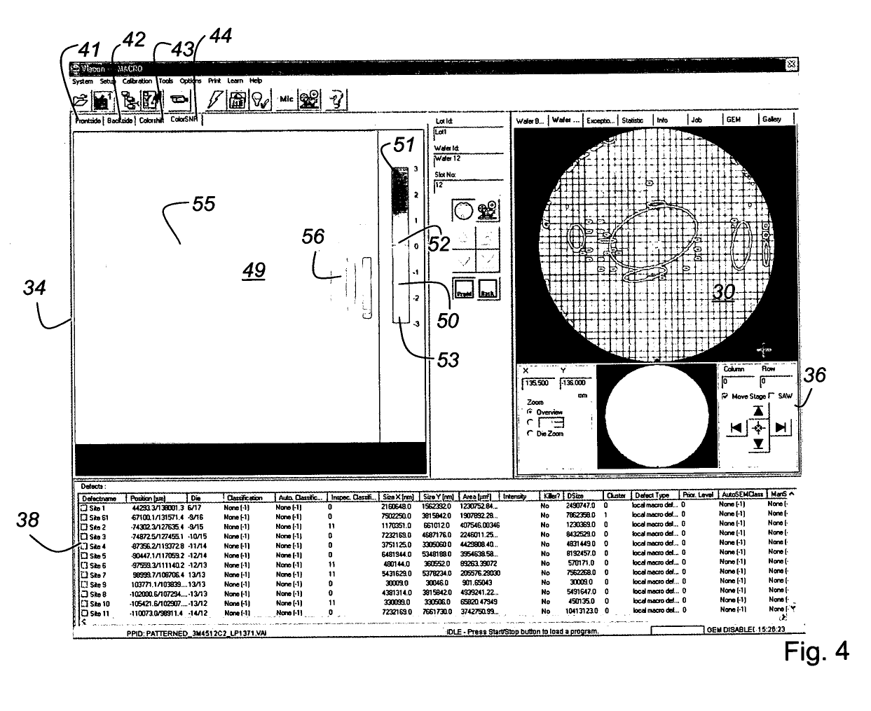

FIG. 4 is a view of the surface of wafer 30, wherein the difference to a threshold value has been formed. In first area 34 a color image of the surface of wafer 30 is shown to the user. The colors for display are taken from a palette 50 also shown in the first area 34 next to the colored resulting image 49 of wafer 30. In the embodiment shown palette 50 is graded from red 51 to white 52 to green 53. Palette 50 therefore facilitates a visualization of the signal-to-noise ratio. The color red 51 indicates that the threshold value has been exceeded. The color white 52 indicates that the threshold value has not been exceeded. The color green 53 indicates that the area or measuring value in question is quite remote from the chosen threshold value.

The color representation using the palette is only one of various possibilities of representation. It is understood that palette 50 described in the present embodiment having the colors red, white and green should not be construed as limiting the invention. To give an illustration of the measuring values obtained by camera 22 from the surface of wafer 30 a color value is associated with each measuring value. This color representation is visually shown to the user in first area 34 of the display.

The resulting image is now generated by associating a certain color value with an area on the surface of the disk-like object in which the optical measuring values are within a predetermined interval. This is done over the entire surface of the disk-like substrate. The result is an image having the same size as the recorded image. By suitably choosing the palette 50, i.e. the association rule between each measuring value and color, illustrative representations of the determined optical measuring values can be obtained which can be promptly and quickly visually recognized by a user.

In the embodiment shown in FIG. 4 the difference between a measuring value and the threshold value is used as the measuring value. As mentioned above, a gradation from green to white to red is used as the palette, so that the signal-to-noise ratio can be very well visualized. Green areas 55 arise where the measuring value is remote from the threshold value, red areas 56 indicate regions on the surface of wafer 30, where the measuring value exceeds the threshold values or the threshold. With this kind of representation the determination of threshold values is simplified and it is not necessary to incrementally change the thresholds before errors can be detected.

Where the measuring method according to the present invention is sufficiently sensitive that defects are detected which are not easily discernible in the optically recorded image, feedback to the recorded image is important. Since the resulting image and the recorded image have the same size it is easy to switch over between the two views and so to evaluate the measurement.

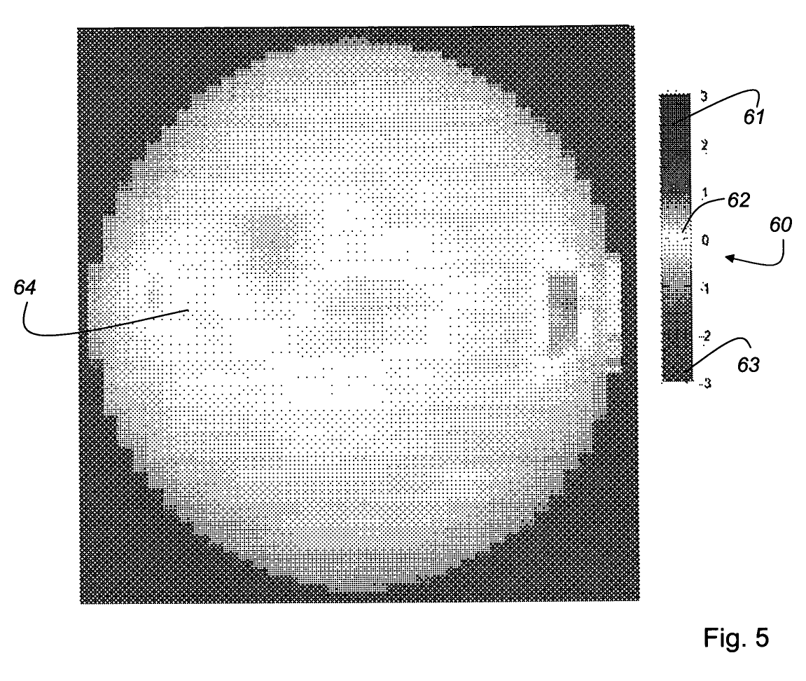

FIG. 5 shows a false-color image of the surface of wafer 30 in black and white. In analogy to palette 40 in FIG. 4, palette 60 in FIG. 5 shows a change of black and white symbols. The symbols indicating that the threshold value is exceeded are located in top area 61 of palette 60. In the middle area 62 of palette 60, there is no exceeded threshold value, and the areas of the disk-like object have no defects. In the bottom area 63 of palette 60, the symbols indicate that the measuring value is remote from the threshold value. In analogy to palette 60, in resulting image 64 of wafer 30, the areas are indicated with the corresponding symbols, so that a user can easily recognize the areas in which there is a possible defect.

What is claimed is:

1. A method of optically inspecting and visualizing optical measuring values from at least one image of a disk-like object, comprising the steps of:
recording of the at least one image of the at least one disk-like object having a surface, a plurality of optical measuring values being generated from the at least one recorded image;
associating each optical measuring value with a color value; and
generating a resulting image, a color value being selected from a predetermined palette being associated with an area of the surface of the disk-like object, the optical measuring values being within a predetermined interval.

2. The method according to claim 1 wherein the disk-like object is placed on a stage, the stage being movable in a first direction X and a second direction Y, an image recorder having a field of view smaller than an entirety of the surface of the disk-like object, the recording step including imaging the entirety of the surface of the disk-like object, the disk-like object being imaged by the image recorder in a meandering or raster fashion.

3. The method according to claim 2 wherein the resulting image has a same form as the recorded image of the disk-like object.

4. The method according to claim 1 wherein the palette has at least three different colors in which the resulting image is shown.

5. The method according to claim 1 wherein the palette represents an association rule between each measuring value and a color value, images of the surface of the disk-like object being shown in other colors than the recorded image of the disk-like object.

6. The method according to claim 5 wherein a threshold value is determined.

7. The method according to claim 6 wherein a difference is formed between the measuring values of the recorded image of the disk-like object and the threshold value.

8. The method according to claim 1 wherein the palette is graded from green to white to red.

9. The method according to claim 8 wherein the gradation of the palette from green to white to red is for visualizing the signal-to-noise ratio, green areas arising where the measuring value is remote from a threshold value and red areas indicate regions where the measuring value exceeds the threshold value.

10. The method according to claim 1 wherein the recorded image of the disk-like object and the resulting image are shown on a display of a system for optically inspecting a disk-like object, wherein for evaluating defects on the disk-like object a switchover can be made between the recorded image of the disk-like object and the resulting image.

11. The method according to claim 1 wherein the disk-like object is a flat panel display.

12. The method according to claim 1 wherein the disk-like object is a wafer.
